(19) United States
(12) Patent Application Publication
(10) Pub. No.: US 2005/0108743 A1
(43) Pub. Date: May 19, 2005

(54) Disc device and loading method for recording disc

(75) Inventor: Katsuaki Kawamura, Kawagoe-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: PIONEER CORPORATION, Tokyo (JP)

(21) Appl. No.: 10/964,743

(22) Filed: Oct. 15, 2004

(30) Foreign Application Priority Data
Nov. 17, 2003 (JP) 2003-386505

(51) Int. Cl. G11B 7/00

(52) U.S. Cl. 720/708

(57) ABSTRACT

A portable CD player (100) holds a reproduced CD (10A) using a disc table (271) supporting an information recording surface of the reproduced CD (10A) and reproduced CD engaging sections provided such that they abut on a non-recording hole edge of the reproduced CD (10A). The portable CD player (100) holds a spare CD (10B) stacked on the reproduced CD (10A) in contact therewith using spare CD engaging sections provided such that they abut on a non-recording hole edge of the spare CD (10B) and the disc table (271) through the reproduced CD (10A).

### BACKGROUND OF THE INVENTION

1. Field of the Invention

The present invention relates to a disc device into which a plurality of recording discs can be loaded and a loading method for a recording disc.

2. Description of Related Art

Portable disc devices that can be carried about for use have been known as a configuration for satisfying needs of users who wish to enjoy listening to music recorded on CDs (Compact Discs) at any place and any time. When someone wishes to enjoy music recorded on a plurality of CDs with such a portable disc device, for example, while he or she is out, it is necessary to carry spare CDs other than a CD that is being reproduced by the portable disc device by housing them, for example, in a disc housing case. Hereinafter, a CD that is being reproduced by a portable disc device is referred to as a “reproduced CD”, and CDs other than the reproduced CD that are held in reserve are referred to as “spare CDs” for convenience of description.

Portable disc devices that can be loaded with spare CDs in addition to a reproduced CD are known (for example, see Document 1: Japanese Utility Model Laid-Open No. Hei5-59692, page 2 to 3 and Document 2: Japanese Patent Laid-Open No. 2000-207879, the left column of page 3 to the right column of page 4).

A portable disc device in Document 1 includes a main body in which members for reproducing a CD are provided and a spare CD housing section, which is formed integrally with a bottom part of the main body. The spare CD housing section includes a housing section main body for housing spare CDs, an insertion hole which provides communication between the housing section main body and the outside, and a holder for holding the spare CDs housed in the housing section main body. When spare CDs are loaded into the portable disc device, the spare CDs are first housed in the housing section main body by inserting them through the insertion hole of the spare CD housing section. Then, the housed spare CDs are held with the holder to prevent them from falling from the housing section main body. The spare CDs are thus loaded into the portable disc device.

A portable disc device in Document 2 includes a main body in which members for reproducing a CD are provided and a lid part attached to the main body so as to open and close. The lid part includes a spare CD setting member for setting spare CDs such that they face a reproduced CD disposed in the main body. When spare CDs are loaded into such a portable disc device, the spare CDs are set in the spare CD setting member by opening the lid part.

However, the portable disc device in Document 1 has the spare CD housing section that is dedicated to housing of spare CDs. The portable disc device in Document 2 has the spare CD setting member that is dedicated to setting of spare CDs. That is, both of the portable disc devices in Documents 1 and 2 have a dedicated member for housing or setting spare CDs. Since there is such a need for providing a dedicated member for housing or setting spare CDs in addition to members for reproducing a CD to be reproduced, a problem arises, for example, in that the size of a portable disc device is increased. Further, since the number of constituent members of a portable disc device is significantly increased, another problem arises in that the device becomes heavy.

### SUMMARY OF THE INVENTION

An object of the present invention is to provide a disc device and a loading method for a recording disc in which a plurality of recording discs can be loaded using a simple configuration.

A disc device according to an aspect of the present invention includes: a disc insertion section inserted into a hole of a recording disc; a disc driver for rotating the disc insertion section in a circumferential direction of the recording disc; and a disc holding section provided at the disc insertion section for holding the recording disc, the disc holding section holding a plurality of the recording discs in such a state that they are stacked one on another.

A disc device according to another aspect of the present invention includes: a disc insertion section which is inserted into a hole of a recording disc and which can hold a plurality of the recording discs such that they are stacked one on another; and a disc driver for rotating the disc insertion section in a circumferential direction of the recording disc; the disc insertion section has a plurality of abutting members which abut on an edge of a hole of one of the recording discs while being kept inserted in the hole of the one recording disc and abut on another recording disc while abutting on the edge of the hole of the one recording disc.

A loading method for a recording disc according to still another aspect of the present invention in which a plurality of recording discs are loaded into a disc device, the disc device having a disc insertion section inserted into a hole of a recording disc and having a plurality of abutting members which abut on edges of the holes of the plurality of recording discs to allow the recording discs to be held one on another, a disc driver for rotating the disc insertion section in a circumferential direction of the recording discs, and a read-out unit for reading out information recorded on at least one of the plurality of recording discs, the method including the steps of: inserting the disc insertion section into a hole of a recording disc from which information is to be read-out by the read-out unit among the plurality of recording discs and abutting one of the abutting members on an edge of the hole of the recording disc to hold the recording disc; and inserting the disc insertion section into holes of the other recording discs from which no information is to be read out by the read-out unit and abutting the one abutting member and the other abutting members on edges of the holes of the other recording discs to hold the other recording discs stacked on the recording disc to be read.

### BRIEF DESCRIPTION OF THE DRAWINGS

FIG. 1 is a plan view of a CD according to an embodiment of the present invention showing a general configuration thereof;

FIG. 2 is a sectional view of the CD in the embodiment of the present invention showing the general configuration thereof;

FIG. 3 is a schematic view of a portable CD player in the embodiment of the present invention showing a general configuration thereof;

FIG. 4 is a schematic view of the interior of a driver housing in the embodiment of the present invention showing a general configuration thereof;

FIG. 5 is a sectional view of a disc holder in the embodiment of the present invention showing a general configuration thereof; and

FIG. 6 is a perspective plan view of the disc holder in the embodiment of the present invention showing the general configuration thereof.

### DETAILED DESCRIPTION OF PREFERRED EMBODIMENT(S)

An embodiment of the invention will now be described based on the drawings. Although the embodiment will be described with reference to a portable CD player for playing back music recorded on a CD (Compact Disc) by way of example, the invention is not limited to such a device.

[Configuration of a CD]

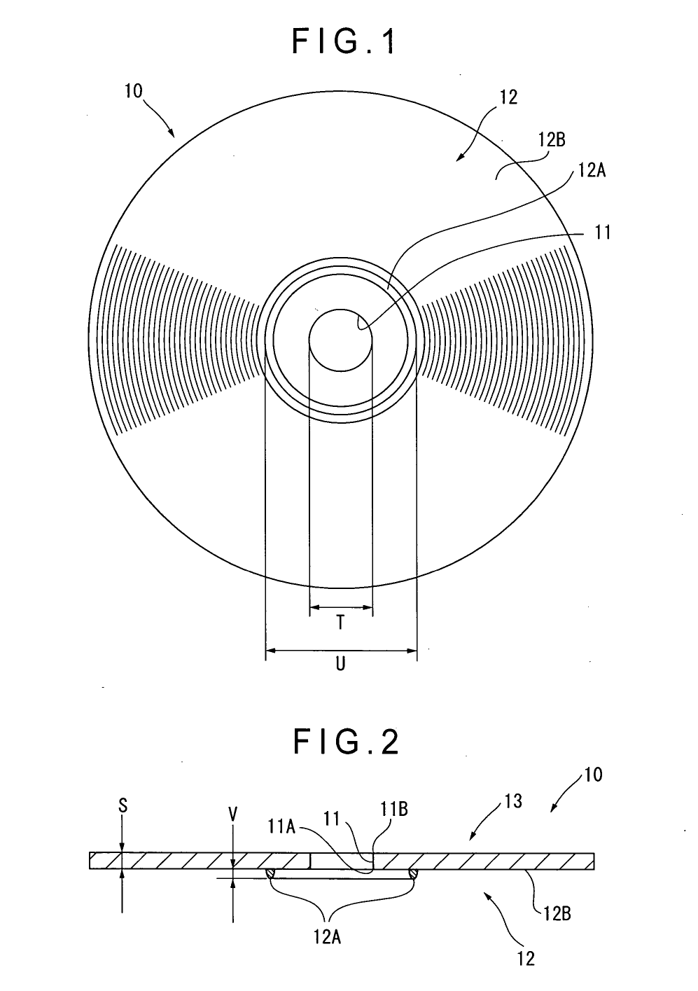

A configuration of a CD to be played back with the portable CD player of the embodiment will be first described based on the drawings. FIG. 1 is a plan view of the CD showing a general configuration thereof. FIG. 2 is a sectional view of the CD showing the general configuration thereof.

In FIG. 1, reference numeral 10 represents a CD as a recording disc. Although a CD will now be described as an example of a recording disc, the invention is not limited to the same and may be applied to other optical discs such as DVDs (Digital Versatile Discs), magneto-optical discs, magnetic discs, and all types of recording discs such as write-once types and rewritable types. The CD 10 is formed like a circular plate having a center hole 11 as a hole section substantially in the middle thereof. As shown in FIG. 2, the surface of one side of the disc constitutes an information recording surface 12 on which various types of information are recorded, and the surface on the other side of the same constitutes a non-recording surface 13 on which no information is recorded. The diameter of the CD 10, the thickness of the CD 10, and the diameter of the center hole 11 are defined as 120 mm, 1.2 mm, and 15 mm, respectively, according to ISO (International Organization for Standardization)/IEC (International Electrotechnical Commission) 10149. Hereinafter, the thickness of the CD 10 and the diameter of the center hole 11 will be referred to as a “CD thickness S” and a “hole diameter T”, respectively, for convenience of description. For convenience of description, an edge of the center hole 11, which is contiguous with information-recording surface 12, will be referred to as a “recording hole edge 11A”, and an edge of the center hole which is contiguous with the non-recording surface 13 will be referred to as a “non-recording hole edge 11B”.

A stack rib 12A and a volume space 12B are provided on the information recording surface 12. The stack rib 12A is provided for preventing the information-recording surface 12 from being damaged similarly to those on common CDs. The stack rib 12A is formed such that it appears as a circle having a diameter U substantially in the middle of the CD 10 and is formed with a convex sectional configuration so as to project above the information recording surface 12. FIG. 2 is a schematic diagram for explaining the stack rib 12A, and the actual height of the stack rib 12A is set at a value that is sufficiently smaller than the CD thickness S. Hereinafter, the height of the stack rib 12A will be referred to as a “rib height V” for convenience of description. The volume space 12B is provided outside the stack rib 12A. For example, audio data are recorded in the volume space 12B as data for outputting music as sounds. Although a configuration in which audio data are recorded in the volume space 12B has been described by way of example, it is not essential that audio data are recorded in the volume space 12B.

[Configuration of Portable CD Player]

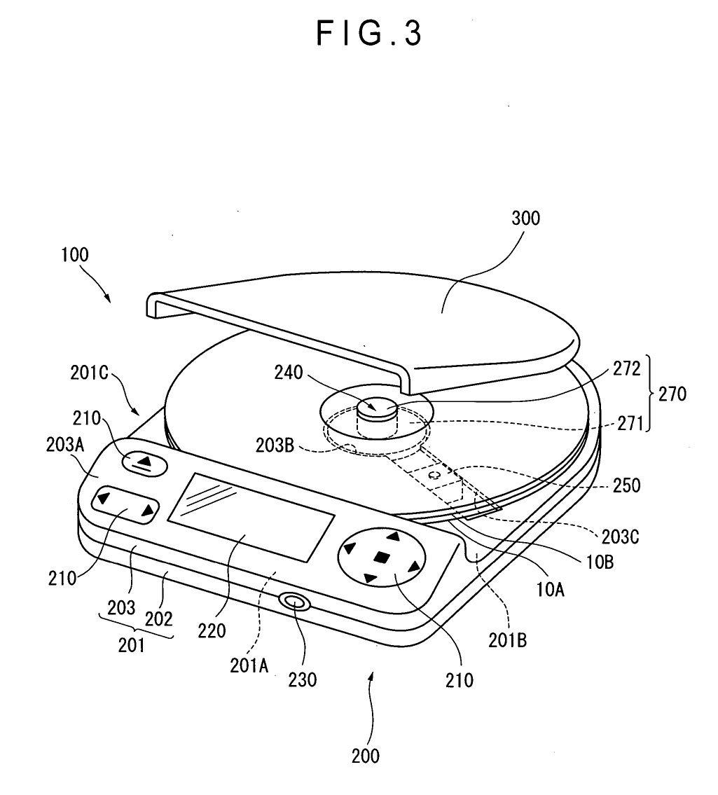

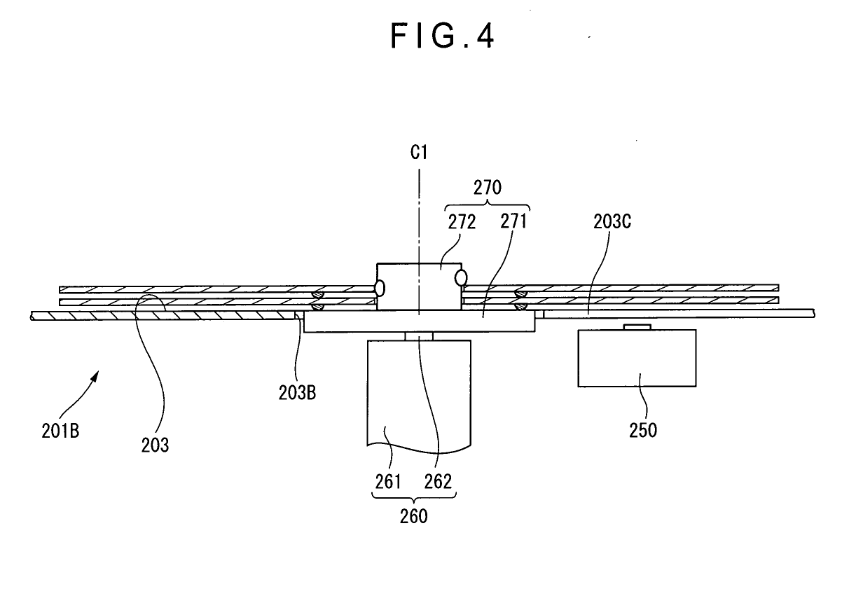

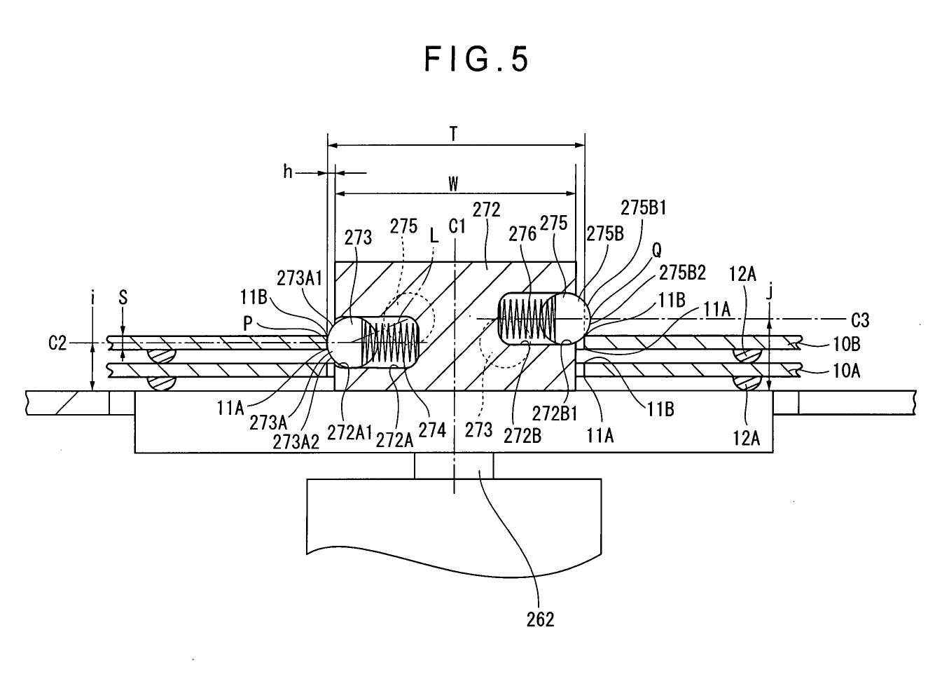

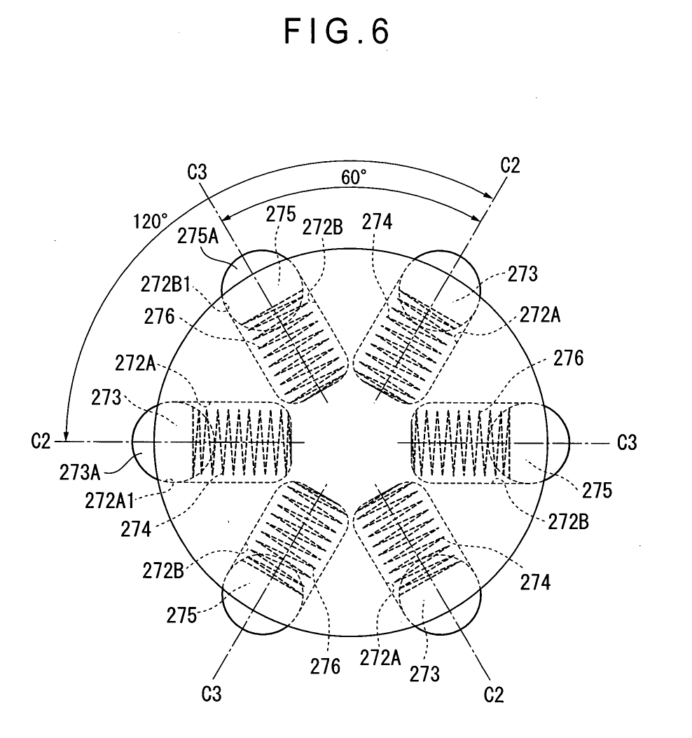

A configuration of a portable CD player will now be described based on the drawings. FIG. 3 is a schematic view of a portable CD player according to this embodiment showing a general configuration thereof. FIG. 4 is a schematic view of the interior of a driver housing showing a general configuration thereof. FIG. 5 is a sectional view of a disc holder showing a general configuration thereof. FIG. 6 is a perspective plan view of the disc holder showing the general configuration thereof.

In FIG. 3, reference numeral 100 represents the portable CD player as a disc device. The portable CD player 100 reproduces music recorded on the CD 10. The portable CD player 100 is a device which can be loaded with another CD 10 in addition to the CD 10 to be reproduced. Hereinafter, for convenience of description, the CD 10 to be reproduced will be referred to as a “reproduced CD 10A” as one of recording discs, and the CD 10 other than the reproduced CD 10A will be referred to as a “spare CD 10B” as another recording disc. The portable CD player 100 has a main body 200 and a lid part 300.

The main body 200 has a case 201 formed in a substantially box-like shape having a small thickness. The case 201 has a lower case 202 substantially in the form of a thin box that is formed with an opening, which is not shown, on the top side thereof and an upper case 203 in the form of a thin box that is formed with an opening, which is not shown, on the bottom side thereof, the upper case closing the opening of the lower case 202.

The lower case 202 is formed of, for example, a material such as an aluminum alloy or plastic. The lower case 202 is formed with a substantially arcuate shape on the side of one edge thereof (hereinafter referred to as a “first edge”) such that it appears substantially like the character D in a plan view.

The upper case 203 is formed of, for example, plastic. The upper case 203 is formed with substantially the same arcuate shape as that on the first edge of the lower case 202 such that it appears substantially like character D in a plan view. An operation unit disposing section 203A is provided on the top of the upper case 203 on the side of another edge thereof (hereinafter referred to as a “second edge”) such that it projects above a top surface of the case on the side of the first edge thereof. A substantially circular disc-table exposure hole 203B is formed on the top surface of the upper case 203 on the side of the first edge thereof, the exposure hole 203B being formed in the middle of the surface when viewed in the direction of the plane. A substantially rectangular pick-up exposure hole 203C is formed on the top surface of the upper case 203 on the side of the first edge thereof, the exposure hole 203C being formed in a region spanning between the disc-table exposure hole 203B and the neighborhood of the edge. The case 201 is assembled and formed by mounting the upper case 203 such that the operation unit disposing section 203A is located on the side of another edge of the lower case 202. In the case 201, a controller housing 201A is defined in a position associated with the operation unit disposing section 203A where the case has a great height in the vertical direction, and a driver housing 201B is defined in a position where the case has a smaller height in the vertical direction.

Three operation knobs 210, a display, an audio output terminal 230, and a processing section which is not shown are provided in the controller housing 201.

The operation knobs 210 are disposed such that they are exposed to the outside in the vicinity of a corner of the operation knob disposing section 203A. The operation knobs 210 are used for setting and inputting the contents of operations of the portable CD player 100. The contents of operations set and input with the operation knobs 210 include various operations such as starting and stopping reproduction of the reproduced CD 10A, skipping a piece of music during reproduction, and opening the lid part 300. The operation knobs 210 output predetermined processing signals to the processing section appropriately to operations of inputting operation contents.

The display 220 is constituted by, for example, a liquid crystal panel. The display 220 is disposed such that a display surface thereof is exposed to the outside substantially in the middle of the operation unit disposing section 203A. The display 220 appropriately displays the contents of an operation of the portable CD player 100, the name and reproducing time of a piece of music that is being reproduced, and so on based on display data from the processing section. The display 220 is not limited to liquid crystal panels, and any display such as an organic EL (Electro-Luminescence) panel, PDP (Plasma Display Panel), CRT (Cathode-Ray Tube), FED (Field Emission Display) or electrophoretic display panel may be used.

The audio output terminal 230 is a jack into which a plug of an earphone (not shown) is inserted. The audio output terminal 230 is disposed such that it is exposed to the outside on a face of the case 201 on the side of the second edge thereof. The audio output terminal 230 outputs audio signals from the processing section to the earphone through the plug.

The processing section controls operations of the portable CD player 100. Specifically, the processing section converts processing signals from the operation knobs into operation signals. The operations signals are output to a motor 260 and a pick-up 250 which will be described later. The processing section also converts processing signals from the operation knobs 210 into display data. The display data are output to the display 220. Further, the processing section converts audio data from the pick-up 250 into audio signals. The audio signals are output to an audio signal output terminal 230 which will be described later.

The driver housing 201B houses a rotation drive section 240 which is disposed substantially in the middle of the driver housing 201B when viewed in the direction of the plane of the same and the pick-up 250 as read-out unit which is disposed such that it can be advanced and retracted in the longitudinal direction of the pick-up exposure hole 203C of the upper case 203.

The rotation drive section 240 holds the CDs 10A and 10B and rotates them in a circumferential direction thereof. As shown in FIG. 4, the rotation drive section 240 has the motor 260 as a disc driving section and a disc setting section 270.

The motor 260 has a motor body 261 and a motor shaft 262 provided so as to project from one side of the motor body 261 and driven for rotation by the motor body 261. The motor body 261 is disposed substantially in the middle of the driver housing 201B when viewed in the plane of the same such that the axial direction of the motor shaft 262 is orthogonal to the direction of the plane. The motor body 261 rotates the motor shaft 262 appropriately based on the operation signals from the processing section.

The disc setting section 270 has a disc table 271 which is formed substantially like a circular plate and which also serves as a disc holding section and a disc holder 272 which is provided so as to project from the top surface of the disc table 271 substantially in the middle thereof and which is formed substantially like a short column. Although a configuration in which the disc table 271 is formed substantially like a circular plate has been described by way of example, the invention is not limited to the same, and any other appropriate shape such as a shape substantially like a polygonal plate or a shape substantially like a cross plate may be employed. Although a configuration in which the disc holder 272 is formed substantially like a column has been described by way of example, the invention is not limited to the same, and any other appropriate shape such as a shape substantially like a polygonal pole or a substantially cylindrical shape may be employed. Further, although a configuration in which the disc table 271 and the disc holder 272 are provided as separate elements has been described by way of example, the invention is not limited to the same, and a configuration may be employed in which those elements are integrally molded.

The disc table 271 is formed of, for example, a material such as plastic or rubber. An inserting section (not shown) into which the end of the motor shaft 262 is inserted is formed in the middle of the disc table 271 when viewed in the direction of the plane thereof. The disc table 271 has a diameter which is greater than the diameter U of the stack rib 12A formed on the reproduced CD 10A, and it is formed substantially like a circular plate which has a diameter smaller then the diameter of the disc-table exposure hole 203B of the upper case 203. The disc table 271 is disposed such that its top surface is exposed to the outside at the disc-table exposure hole 203B of the upper case 203 and such that the top surface is substantially flush with the top surface of the upper case 203 on the side of the first edge thereof. Although the disc table 271 is described as having a diameter greater than the diameter of the stack rib 12A in this embodiment, this is not limiting the invention, and the diameter of the disc table 271 may be smaller than the diameter of the stack rib 12A, for example. In this case, the disc table 271 is disposed such that its top surface is exposed to the outside at the disc-table exposure hole 203B and such that the top surface of the disc table 271 projects above the top surface of the upper case 203 on the side of the first edge thereof.

The disc holder 272 is formed of, for example, a material such as plastic. The disc holder 272 is coupled such that its axis C1 is substantially aligned with the axis of the motor shaft 262. As shown in FIG. 5, the disc holder 272 is formed like a short column having a holder diameter W that is smaller than the hole diameter T of the CDs 10A and 10B. Hereinafter, the distance between the reproduced CD 10A and the disc holder 272, for example, when the reproduced CD 10A is set in the disc holder 272 will be referred to as a “gap length h” for convenience of description. As shown in FIG. 6, the disc holder 272 is provided with three engaging section holders 272A which have an axis C2 extending in the radial direction of the substantially columnar shape of the disc holder 272 and which are substantially cylindrically formed and three engaging section holders 272B which have an axis C3 extending in the radial direction of the substantially columnar shape of the disc holder 272 and which are formed substantially identically to the engaging section holders 272A. The engaging section holders 272A will be detailed in the following description, and the engaging section holders 272B having substantially the same configuration will be simply described.

As shown in FIG. 5, the engaging section holders 272A are formed with a substantially cylindrical shape having a diameter greater than the CD thickness S such that their axes C2 are substantially orthogonal to the axis C1. Although a configuration in which the engaging section holders 272A have a diameter greater than the CD thickness S will be described by way of example, the invention is not limited to the same, and a configuration may be employed in which the holders have a diameter that is substantially equal to the CD thickness S or a diameter smaller than the CD thickness S. The engaging section holders 272A are formed at substantially equal intervals in the circumferential direction of the substantially columnar shape of the disc holder 272. That is, they are formed on a circumferential surface of the disc holder 272 at intervals of about 1200 when viewed from above. Further, as shown in FIG. 5, the engaging section holders 272A are formed in positions in which an interval i between the axes C2 and the disc table 271 is (3/2× (CD thickness S)+2× (rib height V)). That is, the engaging section holders 272A are formed such that their axes C2 are substantially positioned at the center of the spare CD 10B disposed in the disc setting section 270, when viewed in the direction of the thickness of the CD 10B. Although the engaging section holders 272A are formed at the above described height and positions in the configuration described here by way of example, the invention is not limited to the configuration.

Fall-stops 272A1 are formed in the vicinity of circumferential surfaces of the engaging section holders 272A. The fall-stops 272A1 are formed with a diameter smaller than the diameter of reproduced CD engaging sections 273 to be described later which are substantially spherically formed. The fall-stops 272A1 are formed such that parts of the reproduced CD engaging sections 273 project a distance greater than the gap length h from the circumferential surfaces when the reproduced CD engaging sections 273 abut on the fall-stops 272A1. Hereinafter, the projections of the reproduced CD engaging section 273 will be referred to as “projections 273A” for convenience of description. Further, the peaks of the projections 273A above the circumferential surfaces or points of intersection between the projections 273A and the axes C2 will be referred to as “peaks P” for convenience of description. Furthermore, for convenience of description, surfaces of the projections 273A located above the peaks P will be referred to as “upper surfaces 273A1”, and surfaces located below the peaks P will be referred to as “lower surfaces 273A2”. The parts of the fall-stops 272A1 on which the reproduced CD engaging sections 273 abut are formed in an arcuate shape that is substantially identical to the outline of the reproduced CD engaging sections 273. Although a configuration has been described in which the fall-stops 272A1 are formed in an arcuate shape that is substantially identical to the outline of the reproduced CD engaging sections 273, the invention is not limited to the same, and other configurations may be appropriately employed.

The reproduced CD engaging sections 273 as contact members that also serve as disc holding sections and abutting members are disposed in the circumferential surface side of the engaging section holders 272A such that they can move in the direction of the axes C2. A reproduced CD biasing member 274 as a biasing member is disposed in the axis C1 side of each of the engaging section holders 272A, the biasing member also serving as a disc holding section for biasing the CD engaging section 273 in the direction of projecting from the circumferential surface and as an abutting member.

The reproduced CD engaging sections 273 are formed of, for example, a material such as metal or plastic in a substantially spherical shape having a diameter that is substantially equal to the diameter of the engaging section holders 272A. The reproduced CD engaging sections 273 are formed by a material which is mirror-finished on its surface or which has a small frictional coefficient. Although a configuration in which the reproduced CD engaging sections 273 are formed in a substantially spherical shape has been described, the invention is not limited to the same, and other appropriate shapes such as elliptic, hemispherical, and cam-type shapes may be employed. Further, although a configuration has been described in which the reproduced CD engaging sections 273 are formed by a mirror-finished material or a material having a small frictional coefficient, this is not limiting the invention, and any configuration may be employed as long as the edges of the center holes 11 of the CDs 10A and 10B exhibit high slidability on the surface of the reproduced CD engaging sections 273.

The CD biasing members 274 are coil springs which are formed in a substantially cylindrical shape having a diameter substantially equal to the diameter of the engaging section holders 272A. As described above, the CD biasing members 274 bias the reproduced CD engaging sections 273 in the direction of projecting from the circumferential surface. Although a configuration has been described in which coil springs are used as the CD biasing members 274, this is not limiting the invention, and any biasing member such as a plate spring which biases the reproduced CD engaging sections 273 in the direction of projecting from the circumferential surface may be employed.

As shown in FIG. 5, the engaging section holders 272B are formed such that their axes C3 are substantially orthogonal to the axis C1. As shown in FIG. 6, the engaging section holders 272B are formed at substantially equal intervals in the circumferential direction of the substantially columnar shape of the disc holder 272. That is, they are formed on a circumferential surface of the disc holder 272 at intervals of about 120° when viewed from above. Further, the engaging section holders 272B are formed such that they are at intervals of about 60° from the engaging section holders 272A when viewed from above. That is, as shown in FIG. 5, the engaging section holders 272B are formed such that imaginary lines L connecting spare CD engaging sections 275, which will be described later, disposed in the engaging section holders 272B and the reproduced CD engaging sections 273 disposed in the engaging section holders 272A will not be substantially in parallel with the axis C1 of the disc holder 272. The engaging section holders 272B are formed in positions in which an interval j between the axes C3 and the disc table 271 is (5/2 (CD thickness S)+3× (rib height V)). That is, the engaging section holders 272B are formed higher than the engaging section holders 272A. Although the engaging section holders 272B are formed at the above described height and positions in the configuration described here by way of example, the invention is not limited to the configuration as long as they are in positions higher than the engaging section holders 272A.

Fall-stops 272B1 substantially identical in configuration to the fall-stops 272A1 are formed in the vicinity of circumferential surfaces of the engaging section holders 272B. Specifically, the fall-stops 272B1 are formed such that parts of the spare CD engaging sections 275 project a distance greater than the gap length h from the circumferential surfaces when the spare CD engaging sections 275, which are substantially spherically formed, abut on the fall-stops 272B1. Hereinafter, the parts of the spare CD engaging sections 275 projecting from the circumferential surfaces will be referred to as “projections 275A” for convenience of description. The peaks of the projections 275A above the circumferential surfaces or points of intersection between the projections 275A and the axes C3 will be referred to as “peaks Q” for convenience of description. Further, for convenience of description, surfaces of the projections 275A located above the peaks Q will be referred to as “upper surfaces 275A1”, and surfaces located below the peaks Q will be referred to as “lower surfaces 275A2”.

The spare CD engaging sections 275 as contact members that also serve as disc holding sections and abutting members are disposed in the circumferential surface side of the engaging section holders 272B such that they can move in the direction of the axes C3. Spare CD biasing members 276 as biasing members are disposed in the axis C1 side of the engaging section holders 272B, the biasing members also serving as disc holding sections for biasing the spare CD engaging sections 275 in the direction of projecting from the circumferential surface and as abutting members. The spare CD engaging sections 275 are substantially identical to the reproduced CD engaging sections 273 in configuration, and the spare CD biasing members 276 are substantially identical to the reproduced CD biasing members in configuration. Therefore, they will not be described here.

The engaging section holders 272A and 272B are not limited to the above-described configuration, and any other appropriate configuration may be employed. Specifically, for example, the numbers of the engaging section holders 272A and 272B may be changed, and their intervals may be changed from those described above. However, as a minimum configuration for holding the CDs 10A and 10B with the disc table 271 and the disc holder 272, it is preferable to employ the above-described configuration in which three each engaging section holders 272A and 272B are formed and disposed at substantially equal intervals in the circumferential direction of the circumferential surface of the disc holder 272.

The pick-up 250 is disposed such that it is exposed to the outside at the pick-up exposure hole 203C. Based on operation signals from the processing section, the pick-up 250 accordingly reads out audio data recorded in the volume space 12B of the information-recording surface 12 while moving in the longitudinal direction of the pick-up exposure hole 203C or the radial direction of the reproduced CD10A accordingly. Specifically, laser light emitted by a light source which is not shown is radiated toward the volume space 12B of the reproduced CD 10A through the pick-up exposure hole 203C, and audio data recorded on the reproduced CD 10A are read out based on reflected light from the volume space 12B. The read audio data are output to the processing section.

As shown in FIG. 1, the lid part 300 is formed of, for example, a material such as an aluminum alloy or plastic substantially in a thin box-like shape which is open on its bottom side and on the side of the second edge. The first edge side of the lid part 300 is formed substantially identically to the arcuate shape of the first edge of the case 201, and the part as a whole is formed like the character D substantially identically to the driver housing 201B of the case 201 when viewed from above. The lid part 300 is attached to the first edge side of the case 201 so as to open and close with a hinge member that is not shown, and a CD housing space 201C is defined in an open region between the lid part and the case 201. When the lid part 300 is moved in the direction of spacing the second edge side thereof from the case 201, the CD housing space 201C is opened to allow the CDs 10A and 10B to be set and removed. When the part is moved into contact with the case 201, the CD housing space 201C is closed.

[Operations of Portable CD Player]

Operations of the portable CD player 100 will now be described.

[Reproduced CD Loading Operation]

First, an operation of loading the portable CD player 100 with the reproduced CD 10A will be described. In a state in which the portable CD player 100 is loaded with none of the CDs 10, as shown in FIG. 6, the reproduced CD engaging sections 273 are biased by the reproduced CD biasing members 274 in the direction of moving away from the axis C1 and are held in a state in which they abut on the fall-stops 272A1 and the projections 273A project from the circumferential surface. The spare CD engaging sections 275 are biased by the spare CD biasing members 276 in the direction of moving away from the axis C1 and are held in a state in which they abut on the fall-stops 272B1 and the projections 275A project from the circumferential surface. Hereinafter, the above-described states of the CD engaging sections 273 and 275 are referred to as “initial states” for convenience of description.

When the reproduced CD 10A is fitted in the disc holder 272 such that the information recording surface 12 of the reproduced CD 10A faces the disc table 271, the recording hole edge 11A of the reproduced CD 10A first comes into contact with the upper surfaces 275A1 of the spare CD engaging sections 275.

When the reproduced CD 10A is moved toward the disc table 271 in this state, a component of the force in the moving direction acts on the spare CD engaging sections 275. The spare CD engaging sections 275 are moved by the component force in the direction of making the length of the spare CD biasing members 276 shorter against the biasing force thereof. When the reproduced CD 10A is thereafter moved until the non-recording hole edge 11B comes into contact with the lower surfaces 275A2 of the spare CD engaging sections 275, the component force acting on the spare CD engaging section 275 is reduced as a result of the movement of the reproduced CD 10A. As the reproduced CD 10A moves, the spare CD engaging sections 275 are moved by the biasing force of the spare CD biasing members 276 in the direction of expanding the spare CD biasing members 276, and the engaging sections 275 return to the initial state when they are released from the contact with the reproduced CD 10A.

When the reproduced CD 10A is moved until the non-recording hole edge 11B comes into contact with the lower surfaces 275A2 of the spare CD engaging sections 275, the recording hole edge 11A of the reproduced CD 10A also contacts the upper surfaces 273A1 of the reproduced CD engaging sections 273. When the reproduced CD 10A is thereafter moved, an effect similar to that occurred on the spare CD engaging sections 275 causes the reproduced CD engaging sections 273 to move in the direction of contracting the reproduced CD biasing members 274 and to move thereafter in the direction of expanding the reproduced CD biasing members 274. Then, the reproduced CD 10A contacts the lower surfaces 273A2 of the reproduced CD engaging sections 273 at the non-recording hole edge 11B thereof and contacts the disc table 271 at the stack rib 12A thereof. At this time, the reproduced CD engaging sections 273 are located in the direction of making the length of the reproduced CD biasing members 274 shorter than that in the initial state, and the reproduced CD 10A is biased by a component of the biasing force of the reproduced CD biasing members 274 toward the disc table 271. Therefore, the reproduced CD 10A is loaded into the portable CD player 100 in the state in which it is biased against the disc table 271 by the reproduced CD engaging sections 273. Thus, the portable CD player 100 can rotate the reproduced CD 10A integrally with the disc setting section 270 using the motor 260 and can read audio data recorded on the reproduced CD 10A with the pick-up 250. In this state, as described above, the disc table 271 is disposed such that its top surface is substantially flush with the top surface of the main body 200. In this connection, a gap having substantially the same dimension as the rib height V is provided between the information recording surface 12 of the reproduced CD10A and the main body 200 to prevent damage on the information recording surface 12.

[Spare CD Loading Operation]

An operation of loading the portable CD player 100 with the spare CD 10B will now be described. When the spare CD 10B is fitted in the disc holder 272 such that the information recording surface 12 of the spare CD 10B faces the disc table 271 in a state in which the portable CD player 100 is loaded with the reproduced CD 10A, the recording hole edge 11A of the spare CD 10B first comes into contact with the upper surfaces 275A1 of the spare CD engaging sections 275. Although a configuration has been described in which the spare CD 10B is fitted such that the information recording surface 12 of the spare CD 10B faces the disc table 271, the invention is not limited to the same, and the spare CD 10B may be fitted such that the non-recording surface 13 of the spare CD 10B faces the disc table 271. However, the exemplary configuration described herein is preferable as a configuration for preventing the spare CD 10B from being damaged.

When the spare CD 10B is moved toward the disc table 271 in this state, an effect similar to that occurred when loading the reproduced CD 10A causes the spare CD engaging sections 275 to move in the direction of making the length of the spare CD biasing members 276 shorter and to move thereafter in the direction of making the length of the spare CD biasing members 276 longer. Then, the recording hole edge 11A of the spare CD 10B also contacts the upper surfaces 273A1 of the reproduced CD engaging sections 273. When the spare CD 10B is moved thereafter, the reproduced CD engaging sections 273 are moved in the direction of contracting the reproduced CD biasing members 274 by an effect similar to that occurred when the reproduced CD 10A was loaded. Then, as shown in FIG. 5, the spare CD 10B contacts the lower surfaces 275A2 of the spare CD engaging sections 275 at the non-recording hole edge 11B thereof, contacts the peaks P of the reproduced CD engaging sections 273 at the inner circumferential surface thereof, and contacts the non-recording surface 13 of the reproduced CD 10A at the stack rib 12A. At this time, the spare CD engaging sections 275 are located in the direction of making the length of the spare CD biasing members 276 shorter than that in the initial state, and the spare CD 10B is biased by a component of the biasing force of the spare CD biasing members 276 toward the disc table 271. Therefore, the spare CD 10B is loaded in the portable CD player 100 in the state in which it is biased against the disc table 271 by the spare CD biasing members 276 through the reproduced CD 10A. The reproduced CD 10A is loaded in the portable CD player 100 in a state in which it is biased against the disc table 271 by the spare CD biasing members 276 through the spare CD 10B. Thus, the portable CD player 100 can rotate the CDs 10A and 10B integrally with the disc setting section 270 using the motor 260 and can read audio data recorded on the reproduced CD 10A with the pick-up 250. In this state, the spare CD 10B is in contact with the reproduced CD 10A at the stack rib 12A. In this connection, a gap having substantially the same dimension as the rib height V is provided between the information recording surface 12 of the spare CD 10B and the reproduced CD 10A to prevent damage on the information recording surface 12.

In the above-described embodiment, in addition to the disc table 271, the reproduced CD engaging sections 273, the reproduced CD biasing members 274, and the disc holder 272 which are elements like those in the related art, the portable CD player 100 is provided with the spare CD engaging sections 275 and the spare CD biasing members 276. The reproduced CD engaging sections 273 bias the reproduced CD 10A fitted in the disc holder 272 toward the disc table 271 utilizing a component of the biasing force of the reproduced CD biasing members 274. As a result, the reproduced CD 10A is loaded in the portable CD player 100 in a state in which it is pressed against the disc table 271 by the reproduced CD engaging sections 273. The portable CD player 100 rotates the reproduced CD 10A integrally with the disc setting section 270 with the motor 260 and reads audio data recorded on the reproduced CD 10A with the pick-up 250. The spare CD engaging sections 275 bias the spare CD 10B, which is fitted in the disc holder 272 and stacked on the reproduced CD 10A in contact therewith, toward the disc table 271 utilizing a component of the biasing force of the spare CD biasing members 276. Thus, the spare CD 10B is loaded in the portable CD player 100 in a state in which it is pressed by the spare CD engaging sections 275 against the disc table 271 through the reproduced CD 10A. The reproduced CD 10A is loaded in the portable CD player 100 in a state in which it is pressed by the spare CD biasing members 276 against the disc table 271 through the spare CD 10B. The portable CD player 100 rotates the CDs 10A and 10B integrally with the disc setting section 270 with the motor 260 and reads audio data recorded on the reproduced CD 10A with the pick-up 250.

Thus, the portable CD players 100 can be loaded with the reproduced CD 10A and the spare CD 10B only by adding the spare CD engaging sections 275 and the spare CD biasing members 276. Since no dedicated member is newly provided for loading the spare CD 10B in the portable CD layer 100, it is possible to prevent the portable CD player 100 from becoming large-sized and to prevent it from becoming heavy-weight due to a great number of additional components. Further, since the reproduced CD 10A and the spare CD 10B are held in the portable CD player 100 such that they are stacked one over the other, the portable CD player 100 can be prevented from becoming large-sized in the vertical direction. It is therefore possible to provide a portable CD player 100 in which a plurality of CDs 10 can be loaded using a simple configuration.

The portable CD player 100 rotates the CDs 10A and 10B integrally with the disc setting section 270 using the motor 260. Therefore, the portable CD player 100 can be manufactured by making efficient use of a configuration similar to those in the related art or a configuration in which the reproduced CD 10A is rotated integrally with the disc setting section 270 with the motor 260. Therefore, the portable CD player 100 can be manufactured with improved simplicity, and the manufacturing cost can be suppressed.

The spare CD engaging sections 275 bias the spare CD 10B toward the disc table 271 while keeping it in contact with the reproduced CD 10A. Therefore, the size of the CD housing space 201C in which the CDs 10A and 10B are disposed can be minimized when compared to configurations in which the spare CD 10B and the reproduced CD 10A are not contact with each other. This also prevents the portable CD player 100 from becoming large-sized. The spare CD 10B is held by the spare CD engaging sections 275 that are in contact with the non-recording hole edge 11B and the reproduced CD 10A that is in contact with the stack rib 12A on the information recording surface 12. It is therefore not required to provide a dedicated member to be put in contact with the information recording surface 12 of the spare CD 10B in the disc holder 272. This allows the configuration of the portable CD player 100 to be simplified.

The portable CD player 100 has the reproduced CD engaging sections 273 which are provided such that they can be put in contact with the reproduced CD 10A and spaced from the same and the reproduced CD biasing members 274 which bias the reproduced CD engaging sections 273 in the direction of putting them in contact with the reproduced CD 10A. The portable CD player 100 also has the spare CD engaging sections 275 which are provided such that they can be put in contact with the spare CD 10B and spaced from the same and the spare CD biasing members 276 which bias the spare CD engaging sections 275 in the direction of putting them in contact with the spare CD 10B. The CDs 10A and 10B can therefore be loaded in the portable CD player 100 with a simple configuration in which the CD engaging sections 273 and 275 are biased by the CD biasing members 274 and 276, respectively, into contact with the CDs 10A and 10B, respectively. It is therefore possible to simplify the configuration of the portable CD player 100 and to improve manufacturability of the same.

The portable CD player 100 rotates the CDs 10A and 10B integrally with the disc setting section 270 using the motor 260 and reads audio data recorded on the reproduced CD 10A with the pick-up 250. Thus, the portable CD player 100 can read the audio data recorded on the reproduced CD 10A even when it is loaded with a plurality of CDs. It is therefore possible to provide a highly versatile portable CD player 100 which can be loaded with a plurality of CDs 10 and which can read audio data recorded on a reproduced CD 10A.

The portable CD player 100 can read audio data recorded on a reproduced CD 10A even when only the reproduced CD 10A is loaded in the disc setting section 270. It is therefore possible to provide a portable CD player 100 having a higher versatility which can read audio data recorded on a reproduced CD 10A not only when it is loaded with a plurality of CDs 10 but also when it is loaded with only one CD 10.

Substantially spherical members and coil springs which are readily available and generally inexpensive are used as the CD engaging sections 273 and 275 and the CD biasing members 274 and 276, respectively. This allows the manufacturing cost to be suppressed.

As the CD engaging sections 273 and 275, substantially spherical members formed of a mirror-finished material or a material having a small frictional coefficient are used. That is, CD engaging sections 273 and 275 having high slidability are used. Therefore, the CD engaging sections 273 and 275 can be smoothly moved in the engaging section holders 272A and 272B. This facilitates operations of loading and unloading the portable CD player 100 with the CDs 10A and 10B.

The CD engaging sections 273 and 275 are disposed on the disc holder 272 at intervals of 60° when viewed from above. That is, the reproduced CD engaging sections 273 and the spare CD engaging sections 275 are disposed in respective positions such that imaginary lines L connecting them will not be substantially in parallel with the axis C1 of the disc holder 272. As a result, no interference occurs between the CD engaging sections 273 and 275 even if the peaks Q of the spare CD engaging sections 275 and the interval i between the engaging sections 275 and the disc table 271 are made closer to the peaks P of the reproduced CD engaging sections 273 and the interval j between the engaging sections 273 and the disc table 271, respectively, in order to prevent the portable CD player 100 from becoming large-sized. This further helps preventing the portable CD player 100 from becoming large-sized.

The disc holder 272 is provided with the engaging section holders 272A and 272B in which the CD engaging sections 273 and 275 and the CD biasing members 274 and 276 can be housed. The CD engaging sections 273 and 275 are disposed in the circumferential surface side of the engaging section holders 272A and 272B, and the CD biasing members 274 and 276 are disposed in the axis C1 side of the engaging section holders 272A and 272B. As a result, during operations of loading and unloading the CDs 10A and 10B, the user's hand and the CDs 10A and 10B contact only the CD engaging sections 273 and 275 and do not contact the CD biasing members 274 and 276. Therefore, the CD biasing members 274 and 276 can be protected from damage attributable to contact with foreign substances to increase the life of the portable CD player 100.

[Modification of the Embodiment]

The invention is not limited to the above-described embodiment and may be modified as described below within a scope in which the object of the invention can be achieved.

For example, although a configuration has been described in which the CDs 10A and 10B are rotated integrally with the disc setting section 270 by the motor 260 of the portable CD player 100, the invention is not limited to the same, and the following configuration may be employed. Specifically, the disc setting section 270 may be provided with a first disc setting part which holds the reproduced CD 10A and which is rotated by the motor 260 and a second disc setting part which holds the spare CD 10B and which is not rotated by the motor 260. In such a configuration, since it is required to rotate only the first disc setting part holding the reproduced CD 10A with the motor 260 when reading audio data recorded on the reproduced CD 10A, the load on the motor 260 can be made smaller than that in the configuration of the above embodiment in which the disc setting section 270 holding the reproduced CD 10A and the spare CD 10B is rotated. It is therefore possible to use a motor having smaller torque than that of the motor 260 of the above embodiment, which allows any increase in the cost of the component to be suppressed.

Although a configuration has been described in which the spare CD engaging sections 275 bias the spare CD 10B that is in contact with the reproduced CD 10A, the invention is not limited to the same, and the following configuration may be employed. Specifically, the reproduced CD engaging sections 273 may be located closer to the disc table 271 than in the case of their positions in the above embodiment. Then, the reproduced CD 10A may be held by the lower surfaces 273A2 of the reproduced CD engaging sections 273 and the disc table, and spare CD 10B may be held by the upper surfaces 273A1 of the reproduced CD engaging sections 273 and the lower surfaces 275A2 of the spare CD engaging sections 275. In such a configuration, the spare CD 10B and the reproduced CD 10A can be loaded in the portable CD player 100 without putting the CDs 10A and 10B in contact with each other. It is therefore possible to prevent any damage on the reproduced CD 10A, which can otherwise occur when it comes into contact with the stack rib 12A of the spare CD 10B.

Although the disc holding section is constituted by the disc table 271, the CD engaging sections 273 and 275, and the CD biasing members 274 and 276 in the above embodiment, this is not limiting the invention and, for example, the following configuration may be employed. For example, plate springs as a part of the disc holding section may be bent at one end thereof, and the bent parts may be projected from the planar parts of the plate springs as protrusions. Then, the plate springs may be disposed such that their planar parts are substantially in parallel with the circumferential surface of the disc holder 272 with a predetermined interval kept between them and such that the projections are substantially in the same positions as the CD engaging sections 273 and 275. In such a configuration, when the reproduced 10A and the spare CD 10B are loaded, for example, the projections provided substantially in the same position as the spare CD engaging sections 275 are moved toward the circumferential surface of the disc holder 272 as a result of contact with the spare CD 10B, and the ends of the plate springs are then bent toward the disc holder 272. A reaction force resulting from the bending causes the projections to bias the spare CD 10B toward the reproduced CD 10A, and the spare CD 10B can be thus loaded in the portable CD player 100. Since the disc holding section is configured by bending plate springs as thus described, the number of components can be reduced to make the configuration of the portable CD player 100 simpler. Since there is no need for forming the engaging section holders 272A and 272B at the disc holder 272, the manufacturability of the portable CD player 100 can be further improved.

The above-described configuration utilizing plate springs may be further modified into a configuration in which, for example, projecting members formed of a material such as plastic or rubber are bonded to the ends of the plate springs using an adhesive. Such a configuration allows the use of members that are integrally formed as disc holding parts. Since this allows a reduction of the number of assembled members, the manufacturability of the portable CD player 100 can be further improved.

Further, for example, the spare CD engaging sections 275 may be eliminated, and the reproduced CD engaging sections 273 may be constituted by members having, for example, a substantially squared U-shaped section and may be disposed such that the open parts of the substantially squared U-shaped sections face the inner circumferential surface of the center hole 11 of the spare CD 10B. Then, the spare CD 10B may be held by fitting the center hole 11 of the spare CD 10B to the open parts of the substantially squared U-shaped sections of the reproduced CD engaging sections 273, and the reproduced CD 10A may be biased against the disc table 271 by the lower ends of the squared U-shaped sections of the reproduced CD engaging sections 273. In such a configuration, since the CDs 10A and 10B can be loaded in the portable CD player 100 without providing the spare CD engaging sections 275, the number of components can be reduced from that in the configuration of the above embodiment. This further suppresses any increase in the component cost.

Although a configuration has been described in which the pick-up 250 is provided with a function of reading audio data recorded on a CD 10 by way of example, the invention is not limited to the same and, for example, a configuration may be employed in which the pick-up is provided with a function of recording audio data on a CD 10. Such a configuration makes it possible to provide a highly versatile portable CD recorder which can be loaded with a plurality of CDs 10 and which can record audio data on a CD 10. By providing the pick-up 250 with the function of reading audio data recorded on a CD 10 and the function of recording audio data on a CD 10, it is possible to provide a highly versatile portable CD recorder/player which can be loaded with a plurality of CDs 10 and which can record audio data on a CD 10.

Although a configuration has been described by way of example, in which one pick-up 250 is provided in the portable CD player 100 and in which audio data recorded on a reproduced CD 10A are read by the pick-up 250, for example, a following configuration may alternatively be employed. For example, two pick-ups 250 may be provided such that they face each other with a reproduced CD 10A and a spare CD 10B sandwiched between them, and the pick-ups 250 may read audio data recorded on the reproduced CD 10A and the spare CD 10B, respectively. The read audio data may be output to different output devices such as speakers. Such a configuration allows possible to provide a highly versatile portable CD player 100, which can read and output audio data recorded on, for example, two CDs 10 only by itself.

Although a configuration has been described by way of example, in which the CD engaging sections 273 and 275 are disposed in respective positions where imaginary lines L connecting those sections are not substantially in parallel with the axis C1 of the disc holder 272, the invention is not limited to the same, and a configuration may be employed in which those sections are disposed in positions where the imaginary lines L and the axis C1 are substantially in parallel with each other, i.e., the spare CD engaging sections 275 are disposed substantially directly above the respective reproduced CD engaging sections 273. In such a configuration, for example, when a manufacturing apparatus is used which rotates the disc holder 272 about the axis C1 to dispose each of the CD engaging sections 273 and 275 from one direction, it is possible to reduce the number of locations to be set as positions for stopping the disc holder 272. Specifically, six stopping positions must be set for the disc holder 272 at intervals of 60° in the configuration of the above embodiment, whereas it is required to set only three stopping positions at intervals of 120° in this modified configuration. As a result, the configuration of a manufacturing apparatus can be simpler than that allowed by the configuration of the above embodiment, which makes it possible to suppress any increase in the manufacturing cost of the portable CD player 100.

Although a configuration has been described in which one spare CD 10B is held by the spare CD engaging sections 275 by way of example, a configuration may alternatively be employed in which, for example, the spare CD engaging sections 275 are disposed higher than the disposing positions in the above-described embodiment to hold a plurality of spare CDs 10B. In such a configuration, for example, when two spare CDs 10B are held, the spare CD 10B disposed on top is pressed against the disc table 271 by the spare CD engaging sections 275 through the reproduced CD 10A and the other spare CD 10B that is disposed in the middle. The spare CD 10B disposed in the middle is pressed, through the spare CD 10B disposed on top, by the spare CD engaging sections 275 against the disc table 271 through the reproduced CD 10A. Further, the reproduced CD 10A is pressed, through the two spare CDs 10B, by the spare CD engaging sections 275 against the disc table 271. Thus, for example, two spare CDs 10B can be loaded in the portable CD player 100. It is therefore possible to provide a highly versatile portable CD player 100 which can be loaded with a plurality of spare CDs 10B.

A configuration may alternatively be employed in which a plurality of spare CD engaging sections 275 are provided in the direction of stacking spare CDs 10B in the disc holder 272. Such a configuration makes it possible to load spare CDs 10B in the same quantity as the number of the spare CD engaging sections 275 provided in the above-described direction as occasions demand. It is therefore possible to provide a more versatile portable CD player 100 which can be loaded with a plurality of spare CDs 10B as occasions demand.

Although a portable CD player 100 has been described as an example of a disc device, the invention is not limited to the same, and the disc device may be a fixed-type device, which performs reproduction, recording/reproduction, or recording on recording discs such as CDs and DVDs.

### [Effects and Advantages of the Embodiment]

As described above, in the above-described embodiment, in addition to the disc table 271, the reproduced CD engaging sections 273, the reproduced CD biasing members 274, and the disc holder 272 which are elements like those in the related art, the portable CD player 100 is provided with the spare CD engaging sections 275 and the spare CD biasing members 276. The portable CD player 100 holds a reproduced CD 10A with the reproduced CD engaging sections 273 and the disc table 271. The portable CD player 100 holds a spare CD 10B stacked on the reproduced CD 10A with the spare CD engaging sections 275 and the disc table 271 through the reproduced CD 10A. Thus, the portable CD player 100 can be made to hold the reproduced CD 10A and the spare CD 10B by newly providing the spare CD engaging members 275 and the spare CD biasing members 276. Since the portable CD player 100 is therefore provided with no dedicated member for loading the spare CD 10B, the portable CD player 100 can be prevented from becoming large-sized. It is also possible to prevent it from becoming heavy-weight due to a great number of components. Further, since the reproduced CD 10A and the spare CD 10B are held in the portable CD player 100 such that they are stacked one over the other, the portable CD player 100 can be prevented from becoming large-sized in the vertical direction. It is therefore possible to provide a portable CD player 100 into which a plurality of CDs 10 can be loaded with a simple configuration.

In the portable CD player 100, the reproduced CD 10A is held by the disc table 271 which supports the information recording surface 12 of the reproduced CD 10A and the reproduced CD engaging sections 273 which are provided so as to abut on the non-recording hole edge 11B of the reproduced CD 10A. In the portable CD player 100, the spare CD 10B stacked on the reproduced CD 10A in contact therewith is held on the disc table 271 through the spare CD engaging sections 275 provided so as to abut on the non-recording hole edge 11B of the spare CD 10B and the reproduced CD 10A. Thus, the portable CD player 100 can be loaded with the reproduced CD 10A and the spare CD 10B only by newly providing the spare CD engaging sections 275 and the spare CD biasing members 276. The above-described effects and advantages can be thus achieved.

1. A disc device comprising:
a disc insertion section inserted into a hole of a recording disc;
a disc driver for rotating the disc insertion section in a circumferential direction of the recording disc; and
a disc holding section provided at the disc insertion section for holding the recording disc,
wherein the disc holding section holds a plurality of the recording discs in such a state that they are stacked one on another.

2. A disc device according to claim 1, wherein the disc driver rotates the disc insertion section with the plurality of recording discs being kept held by the disc holding section.

3. A disc device according to claim 1, wherein the disc holding section holds the plurality of recording discs with the discs being brought in contact with each other.

4. A disc device according to claim 1, wherein a plurality of the disc holding sections are provided in the direction in which the plurality of recording discs are stacked.

5. A disc device according to claim 1, wherein the disc holding section comprises a contact member provided such that it can be put in contact with the recording disc and a biasing member for biasing the contact member in the direction of putting it in contact with the recording disc.

6. A disc device according to claim 1, further comprising a read-out unit for reading out information recorded on a recording disc, wherein information recorded on at least one of the plurality of recording discs held by the disc holding section is read out by the reading unit.

7. A disc device comprising:
a disc insertion section which is inserted into a hole of a recording disc and which can hold a plurality of the recording discs such that they are stacked one on another; and
a disc driver for rotating the disc insertion section in a circumferential direction of the recording disc, wherein the disc insertion section has a plurality of abutting members which abut on an edge of a hole of one of the recording discs while being kept inserted in the hole of the one recording disc and abut on another recording disc while abutting on the edge of the hole of the one recording disc.

8. A disc device according to claim 7, wherein a plurality of the abutting members are provided in the direction in which the recording discs are stacked.

9. A disc device according to claim 7, wherein the abutting members comprise a contact member for contacting the recording disc, provided such that it can be advanced from and retracted to a part of the disc insertion section facing the hole of the recording disc and a biasing member for biasing the contact member in the direction of projecting it from the part facing the hole.

10. A disc device according to claim 5, wherein the contact members are provided such that they can move in a direction substantially orthogonal to the axis of rotation of the disc insertion section and such that an imaginary line connecting the contact members is not substantially in parallel with the axis of rotation.

11. A disc device according to claim 9, wherein the contact members are provided such that they can move in a direction substantially orthogonal to the axis of rotation of the disc insertion section and such that an imaginary line connecting the contact members is not substantially in parallel with the axis of rotation.

12. A loading method for a recording disc wherein a plurality of recording discs are loaded into a disc device, the disc device having a disc insertion section inserted into a hole of a recording disc and having a plurality of abutting members which abut on edges of the holes of the plurality of recording discs to allow the recording discs to be held one on another, a disc driver for rotating the disc insertion section in a circumferential direction of the recording discs, and a read-out unit for reading out information recorded on at least one of the plurality of recording discs, the method comprising the steps of:
inserting the disc insertion section into a hole of a recording disc from which information is to be read-out by the read-out unit among the plurality of recording discs and abutting one of the abutting members on an edge of the hole of the recording disc to hold the recording disc; and
inserting the disc insertion section into holes of the other recording discs from which no information is to be read out by the read-out unit and abutting the one abutting member and the other abutting members on edges of the holes of the other recording discs disc to hold the other recording discs stacked on the recording disc to be read.
